(19) United States
(12) Patent Application Publication
(10) Pub. No.: US 2002/0178366 A1
(43) Pub. Date: Nov. 28, 2002

(54) Method for performing on behalf of a registered user an operation on data stored on a publicly accessible data access server

(76) Inventor: Amiran Ofir, Jerusalem (IL)

Correspondence Address: BROWDY AND NEIMARK, P.L.L.C., 624 NINTH STREET, NW, SUITE 300, WASHINGTON, DC, 20001-5303, US

(21) Appl. No.: 09/863,873

(22) Filed: May 24, 2001

(51) Int. Cl. H04L 9/00

(52) U.S. Cl. 713/182

(57) ABSTRACT

A method and system for performing on behalf of a registered user an operation on data stored on a publicly accessible data access server coupled to a client machine used by the registered user in such a manner as to prevent unauthorized users from using the data and without requiring decryption by the client machine. The registered user has a unique identifier known to the data access server and further having a password accessible to the data access server. The unique identifier is saved in the data access server in a user space associated with the registered user, who further has a public key and a private key that is encrypted with the password to generate an encrypted private key that is stored together with the public key in the user space. The data access server receives from a user a login request including an identifier of the user and supplementary data that may be used to authenticate the user. It receives a request by a registered user for performing an operation together with a session ID of the user that is allocated to the user during login and is known to a login server connected to the data access server and to which it communicates the session ID for identification thereby, and for receiving from the login server the user's password encrypted in such a manner as to enable decryption by the data access server. The encrypted password is decrypted so as to derive the password associated with the user during the login request, thus enabling the data access server to decrypt the encrypted private key of the registered user and use the registered user's private key to perform the requested operation.

### FIELD OF THE INVENTION

This invention relates to data encryption and in particularly to protection of data stored on a server to which multiple users have access in such a manner that only an authorized user is able to access protected data.

### BACKGROUND OF THE INVENTION

It is frequently required to convey data securely from a server to a plurality of target computers connected thereto. One well-known mechanism for doing this is public key algorithm such as the so-called RSA algorithm developed by Rivest, Shamir, Adleman (RSA) system, as described in Rivest, Shamir and Adleman, “A Method of Obtaining Digital Signatures and Public Key Cryptosystems”, CACM, Vol 21, pp 120-126, February 1978. Reference to this algorithm is given in U.S. Pat. No. 5,557,678 (Ganesan) entitled “System and method for centralized session key distribution, privacy enhanced messaging and information distribution using a split private key public cryptosystem”, which gives a good introduction to the public key encryption algorithm of which RSA is but one example.

U.S. Pat. No. 6,061,448 to Tumbleweed Communications Colporation entitled “Method and system for dynamic server document encryption” discloses a method and system for secure document delivery over a wide area network, such as the Internet. A sender directs a Delivery Server to retrieve an intended recipient's public key. The Delivery Server dynamically queries a certificate authority and retrieves the public key. The public key is transmitted from the Delivery Server to the sender. The sender encrypts the document using a secret key and then encrypts the secret key using the public key. Both encrypted document and encrypted secret key are uploaded to the Delivery Server, and transmitted to the intended recipient. The intended recipient then uses the private key associated with the public key to decrypt the secret key, and uses the secret key to decrypt the document. In an alternative embodiment of the invention, the sender uses the public key to encrypt the document. In yet another embodiment, the server transmits the document to the Delivery Server for encryption.

WO 9703398A1 in the name of Sigurd Sigbjøornsen entitled “Protection of Software Against Use Without Permit” discloses an arrangement to protect freely distributed application software, against utilization without permission of the copyright holder. By encrypting the software employing a first key (k1), which is different from a second key (k2) employed in the decryption, better protection is obtained against unauthorized utilization when the decryption key is kept secret to the user. The second key is stored in an external unit, such as a smart card, accessible to the computer and adapted to return to the host computer, the result of its processing of data received from the host, the result then being utilized in the further execution of the respective program.

Known server-client systems that use public-private key encryption techniques require that the client machine include software to permit the decryption of data received from the server. This reduces the flexibility of the system since a user must have access to a computer in which the necessary decryption software is loaded. This requirement militates against the increasing trend to allow a user to work from any computer, by providing universal access to the Internet from hotel rooms, airport lounges and the like. Since computers provided at premises remote from the user's place of residence will not be set up to perform the required decryption of data received from the server, a user is either unable to access his data or must equip himself with a portable computer: something which is not always either practical or convenient.

### SUMMARY OF THE INVENTION

It is therefore an object of the invention to provide a method for performing on behalf of an authorized user an operation on data stored on a publicly accessible data access server coupled to a client machine used by the authorized user in such a manner as to prevent unauthorized users from accessing said data and without requiring decryption by the client machine.

To this end there is provided in accordance with the invention a method for performing on behalf of a registered user an operation on data stored on a publicly accessible data access server coupled to a client machine used by the registered user in such a manner as to prevent unauthorized users from using said data and without requiring decryption by the client machine, said registered user having a unique identifier known to the data access server and further having a password accessible to the data access server, said unique identifier being saved in the data access server in a user space associated with the registered user, said registered user further having a public key and a private key that is encrypted with said password to generate an encrypted private key that is stored together with the public key in said user space, the method comprising the following steps all carried out by the data access server:

(a) receiving from a user a login request including an identifier of said user and supplementary data that may used to authenticate the user,

(b) verifying that the user is a registered user,

(c) if the user is a registered user:

i) receiving a request by the registered user for performing said operation together with a session ID of said user that is allocated to the user during login and is known to the login server,

ii) communicating the session ID of said user to the login server for identification thereby,

iii) receiving from the login server the user's password encrypted in such a manner as to enable decryption by the data access server,

iv) decrypting the encrypted password so as to derive the password associated with the user during the login request,

v) attempting to decrypt the encrypted private key of the registered user having said unique identifier using said password, and

vi) if the registered user's private key is successfully decrypted, using the registered user's private key to perform said operation on behalf of the registered user.

The method according to the invention protects against unauthorized access to the server not only remotely but also in the event of direct access thereto, since the server does not archive any information that could compromise the security of the user's data, even were a hacker to have direct access to the server's disk.

The user is established as authorized if he is registered and if the password that is fed to the data access server, either directly by the user or via the login server, succeeds in decrypting the encrypted private key of the user identified by the unique identity of the user. Once the server establishes the user as being authorized, it performs operations on the user's data as requested by the user. Such operations include, but are not limited to, forwarding e-mail messages, giving the user access to his mail inbox, and so on.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a block diagram showing functionally a client-server system according to the invention for allowing the server to perform secure operations on behalf of authorized clients only;

FIG. 2 is a flow diagram showing the principal operating steps carried out by a data access server when registering a new client;

FIGS. 3 and 4 are flow diagrams showing alternative approaches taken by the data access server for secure storage of the user's password;

FIG. 5 is a flow diagram showing the principal operating steps carried out by the data access server during subsequent access by a registered client;

FIG. 6 is a flow diagram showing the principal operating steps carried out by a login server according to the invention;

FIG. 7 is a block diagram showing functionally a data access server according to the invention; and

FIG. 8 is a block diagram showing functionally a login server according to the invention.

### DETAILED DESCRIPTION OF SPECIFIC EMBODIMENTS

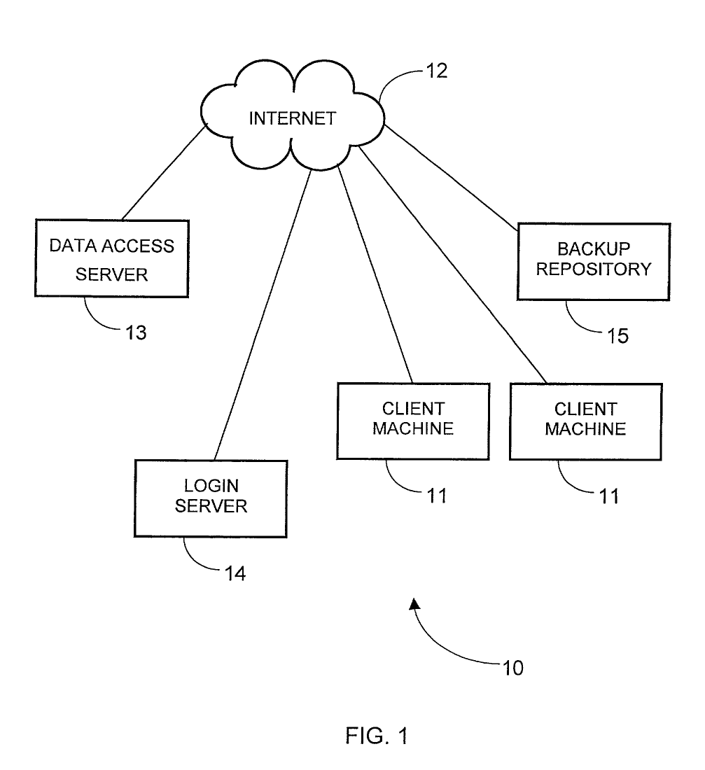

FIG. 1 is a block diagram showing functionally a system designated generally as 10 comprising a plurality of client machines 11 coupled via the Internet 12 to a data access server 13 that performs operations on behalf of a respective registered user. Each registered user stores data on the data access server and has a unique identifier known to the data access server and further having a password accessible to the data access server. The unique identifier is saved in the data access server 13 in a user space associated with the registered user. Each registered user further has a public key and a private key that is encrypted with the password to generate an encrypted private key that is stored together with the public key in the user space on the data access server 13. The actual operations performed by the data access server 13 on behalf of each registered user are not themselves a feature of the invention but may include any operation that is typically carried out by a web server or by a proxy server on behalf of a client. These include receiving and sending e-mail messages; financial transactions; chat sessions and the like. In all cases any client data resident on the data access server 13 is secure in that even if accessed by an unauthorized party, since it is encrypted it is unreadable thereby. Moreover, the data access server 13 is configured to decrypt data only on behalf of an authorized user.

Also connected to the data access server 13 are a remote login server 14 and, optionally, a backup repository 15. The login server 14 stores the user's password during a working session between the user and the data access server, thus obviating the need for the data access server to store it. On the other hand, as will be explained below, the data access server does require the user's password as entered at login for decrypting the user's private key, and receives it from the login server in encrypted format allowing its decryption and subsequent use by the data access server. The backup repository 15 allows backup storage of the user's password so that it may be recovered in the event that the user forgets it.

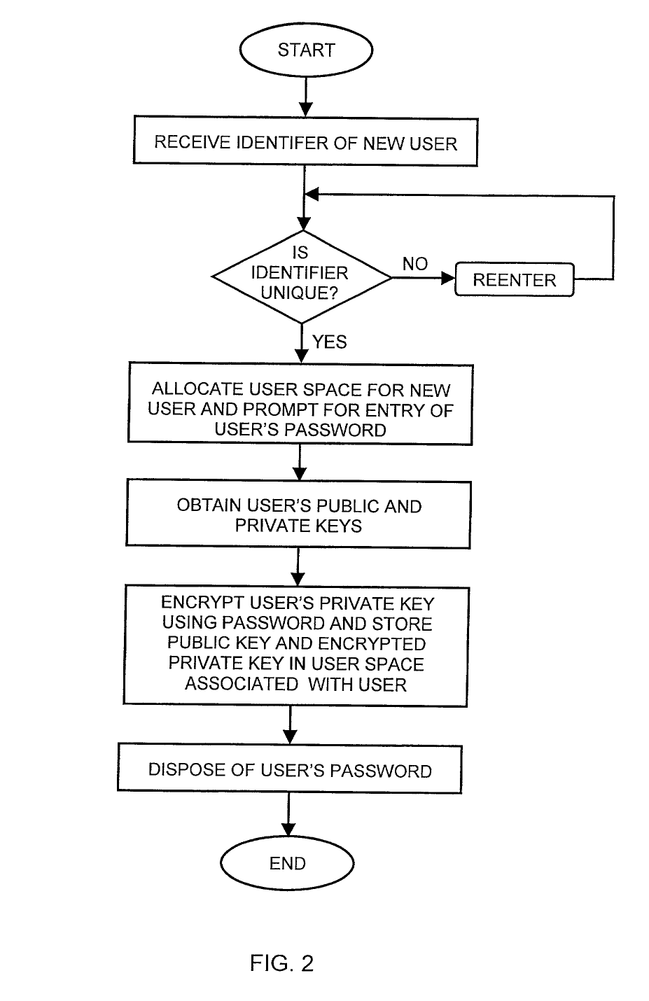

FIG. 2 shows a registration process during which a new user registers with the data access server 13. The user specifies a unique identifier, which is checked for uniqueness. Upon entry of a unique identifier, the data access server partitions a user space in respect of the user and prompts the user for entry of a password. The data access server 13 further requires knowledge of the user's public and private keys. The public key is stored by the data access server 13 in the user space associated with the user. The user's private key is encrypted with the user's password and the encrypted private key is likewise stored by the data access server 13 in the user space associated with the user. The password is not archived by the data access server 13, being stored dynamically only in random access memory, and is used only for the purpose of encrypting the user's unique identity and private key, after which it is disposed of.

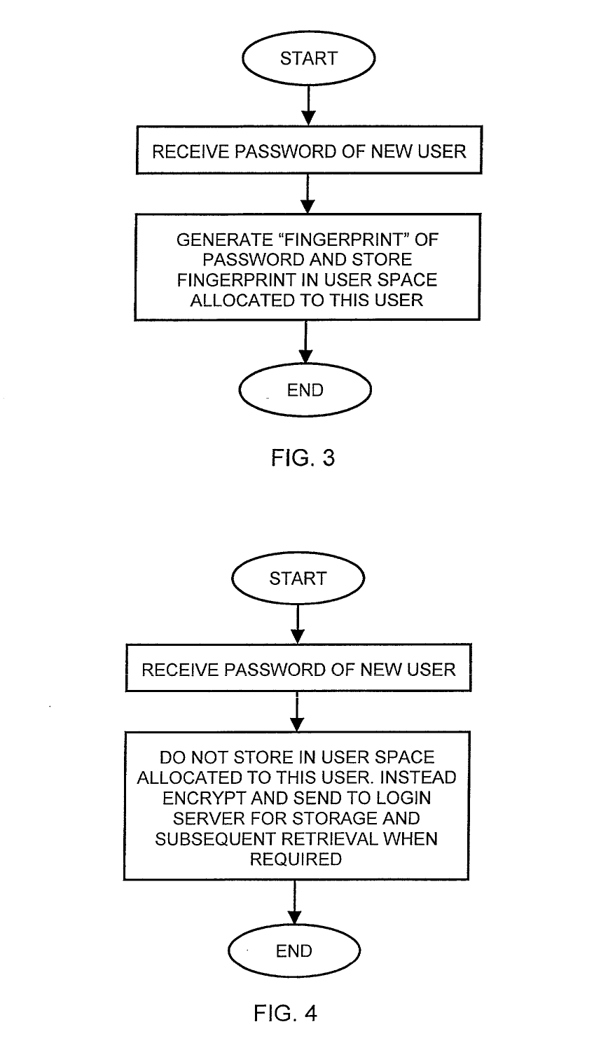

FIGS. 3 and 4 show alternative approaches taken by the data access server 13 for preserving the privacy of the user's password and allowing it to be verified without its being stored on the data access server 13 in a manner that allows exposure by an unauthorized party. As shown in FIG. 3, the data access server 13 generates a “fingerprint” of the password and stores the fingerprint in the user space allocated to the new user. A fingerprint is a one-way only deterministic function that produces a consistent result that cannot be reverse-engineered (at least practically speaking) to reveal the input. Thus, storing the fingerprint of the user's password does not allow the password itself to be decrypted even by someone having direct disk access to the data access server 13.

FIG. 4 shows an alternative approach where the password is encrypted and sent to the login server for storage thereby. Most typically, the password is encrypted with the public key of the login server, thus allowing it to be decrypted by the login server. When the login server 14 later needs to send it to the data access server 13, it encrypts it with the public key of the data access server 13. Thus during all stages of communication the password is encrypted and not amenable to unauthorized decryption.

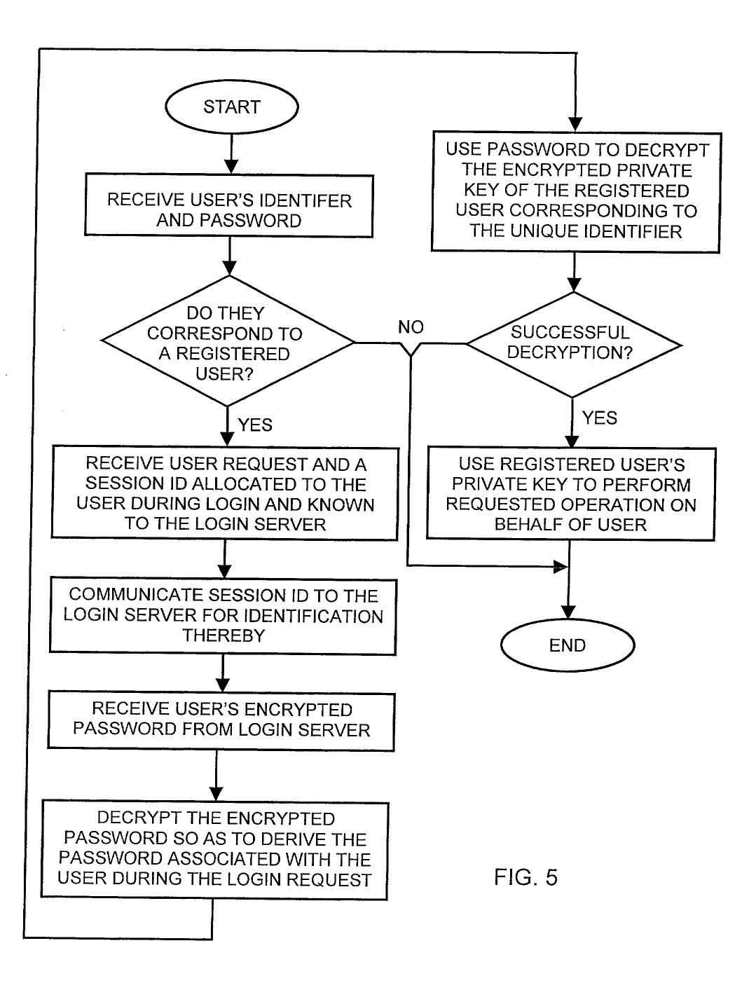

FIG. 5 shows the principal steps carried out by the data access server 13 in respect of a registered client. The data access server receives from a user a login request including the user's identifier and supplementary data that may be used to verify that the user is registered. Typically, the supplementary data is the user's password entered by the user during login. In this case, the same one-way function that was used to generate the fingerprint during registration is used and the resulting fingerprint then compared to the one stored in the identified user's user space. A match indicates that the user is registered. Thereafter, the encrypted password sent to the login server during login is adapted for temporary storage thereby during the current session only. To this end, the login server decrypts the user's encrypted password using the login server's private key and re-encrypts using a temporary key that is stored only in random access memory. This done, the login server saves the re-encrypted password on disk. The temporary key may be a symmetric key and is preferably generated periodically, i.e. from time to time, not necessary at regular intervals of time. Since the temporary key is not archived but is stored only in random access memory, it is very difficult to infiltrate the login server to ascertain the temporary key, and thus almost impossible to decrypt the re-encrypted password, which being stored on disk is accessible. Even here, it should be understood that users access the data access server directly but not the login server, which is actually transparent to most users. However, the invention ensures that even someone with special knowledge and privileges who does have access to the login server, still will not be able to decrypt the user's re-encrypted password. Furthermore, in the event of power failure possibly resulting from a willful attempt by a hacker to make off with the login server, so as to decrypt the user's password, the temporary password will be erased from the random access memory and in this case, even on restoring the power, the login server itself will be unable to decrypt the user's password. This, of course, does not matter since the login server, in any case, erases the user's decrypted password at the end of each session.

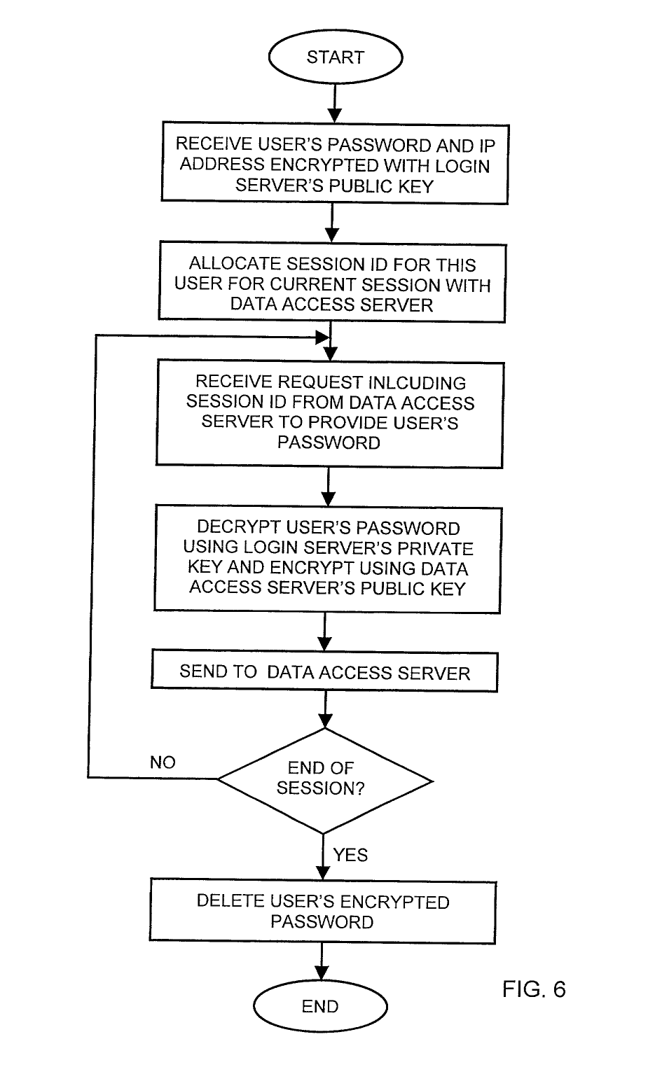

However, as shown in FIG. 6, it may be in the form of a dialog carried out between the data access server and the user wherein the user is prompted to enter personal data that a fraudulent user is unlikely to know. Such data may be details of his family such as his wife's birthday, number of siblings and the like. Correct entry of such data verifies the user and allows his password to be extracted from the login server 14, where it is stored permanently in encrypted form when the user first registered with the data access server 13. Thus, in either case, the user's unique identity and password are now known to the data access server 13. It should be understood however that, at this stage, the user is only verified during logon as matching a registered user. Unless the user's identifier and password are associated with each subsequent access by the user to the data access server, verifying the user at logon does not prove that someone purporting to be this user subsequently is indeed the same registered user.

Specifically, it is to be noted that once a client has logged on to the data access server via the Internet, actual connection to the data access server is effected only when the user clicks on a submit command button or on a link. Thus, each access by the client machine to the data access server is discrete and divorced from any previous access. This means that the mere fact that the user has successfully logged on by providing a genuine identifier and password, does not identify the user as authentic in respect of subsequent access to the data access server unless such access is also accompanied by the user's unique identity and password. However, it is inconvenient for the user to have to enter his identity and password each time he accesses his inbox.

The method according to the invention overcomes this problem by supplying a temporary session ID, which is associated with the unique identifier of the user only at the login server 14 and is sent by client machine to the data access server with each access by the client machine in a manner that is completely transparent to the user. The temporary session ID or a function thereof is embedded in a form that is uploaded by the data access server to the client machine and serves as the command medium between the user and the data access server. The session ID is typically associated with the IP address of the user and may be embedded within a cookie that uniquely identifies the user. In the case where the session ID is embedded within a cookie, the cookie is defined by the data access server to be valid only for as long as the client machine's web browser is open. Thus, upon closing the web browser at the end of the current session, the cookie's validity expires. The cookie further defines the unique identity of the user and may include the IP address of the data access server, to which the client machine's web browser must send it each time the user clicks on a command button or link associated with the form received from the data access server. Once a user has logged on to the data access server all communication between the two is encrypted in manner that allows decryption only by the web browser in the client machine and not by web browser in a different machine. Thus, an eavesdropper would find it most difficult to decrypt any data sent by the client machine to the data access server, let alone to isolate the cookie. Even were this possible in theory, in practice it would have be done within the current session and this is hardly likely. Thus, the session ID serves as a highly secure way to identify the user without requiring him or her to provide a respective unique identity and password upon each access to the data access server.

Moreover, since the session ID is used by the data access server 13 to obtain from the login server 15 the encrypted password of the user, as entered at login, an eavesdropper has no direct access to the user's logon password and so cannot infiltrate the user's data on the data access server.

If the user is a registered user, then the data access server 13 receives a request by the registered user for performing some operation together with a session ID of the user that is allocated to the user during login and is known to the login server. The data access server 13 communicates the user's session ID to the login server 14 for identification thereby, and receives from the login server 14 the user's password encrypted in such a manner as to enable decryption by the data access server 13. The data access server 13 decrypts the encrypted password so as to derive the password associated with the user during the login request, and uses the password in order to attempt to decrypt the encrypted private key of the registered user having the specified unique identifier. If the registered user's private key is successfully decrypted, the data access server uses the registered user's private key to perform the desired operation on behalf of the registered user thus identified.

Having described this procedure it is instructive to review those aspects of the invention that enhance data security. The user operating the client machine 11 has not direct access to the login server 14. However, even supposing that somebody maintaining the login server 14 and having direct access thereto wanted to infiltrate the user's password this would not be possible, since if the user's password is stored by the login server 14, then it is stored in encrypted form (typically encrypted with the private key of the login server) and so is not amenable to unauthorized decryption. The same applies to the data access server 13, where either the user's password is not stored at all; or where only a fingerprint is stored, allowing verification but not infiltration. This prevents a user from masquerading as a registered user and logging on under the name of such a registered user. In most cases where high security data is sent through the Internet, it is sent using SSL (Secure Socket Layer), which encrypts the data. Thus, a hacker wishing to obtain the session ID would first have to decrypt the data, and this is a difficult and time-consuming task. However, even if a hacker, eavesdropping on the line, did manage to intercept a cookie containing a registered user's session ID, to make use of it he would have to unwrap the session ID from the cookie or other means of conveyance since, as a cookie, it would be usable with the web browser of the valid user's machine. The hacker would have to unwrap the session ID and embed it in a cookie customized for his own web browser, so that on sending it to the data access server, it would appear to emanate from the client machine of the registered user. This requires highly specialized skills and is such a time-consuming task that, even assuming it were within the capability of a hacker, the user would likely as not have logged out by the time the hacker had succeeded in masquerading as the registered user. And, of course, if the session ID were correlated to the IP address from which the valid user had logged on to the data access server, then the hacker would have to send the session ID to the data access server as if it originated from this IP address.

Moreover, since the session ID relates only to the current session and does not allow decryption of the user's logon password, the hacker would not be able to logon to the data access server under a false name. To do this would require actual knowledge of the user's unique identifier and password, both of which are conveyed in encrypted form (typically using SSL) and the password is further encrypted using the public key of the receiving party (i.e. data access server or logon server) and so only amenable to decryption by the authorized recipient having the correct private key.

FIG. 6 is a flow diagram showing the principal operating steps carried out by the login server 14. Thus, at logon, the logon server 14 receives the user's password and IP address encrypted with login server's public key and allocates a session ID for this user for current session with data access server 13. The session ID may be a function of the IP address, so as to prevent its being used fraudulently from a different IP address, in the event of its being intercepted. Upon receipt of a request including the session ID from the data access server 13 to provide the user's password, the login server 14 decrypts the user's password using the login server's private key and encrypts it using the data access server's public key. It then sends the encrypted password to the data access server. Upon receiving fiom the data access server 13 notice of termination of the current session, it deletes the user's encrypted password so that subsequent physical infiltration into the login server 14 provides no clue to the user's password. Alternatively, the user may be timed-out by the login server 14 after a predetermined time, in which case user's encrypted password is deleted and the current session ID is invalidated.

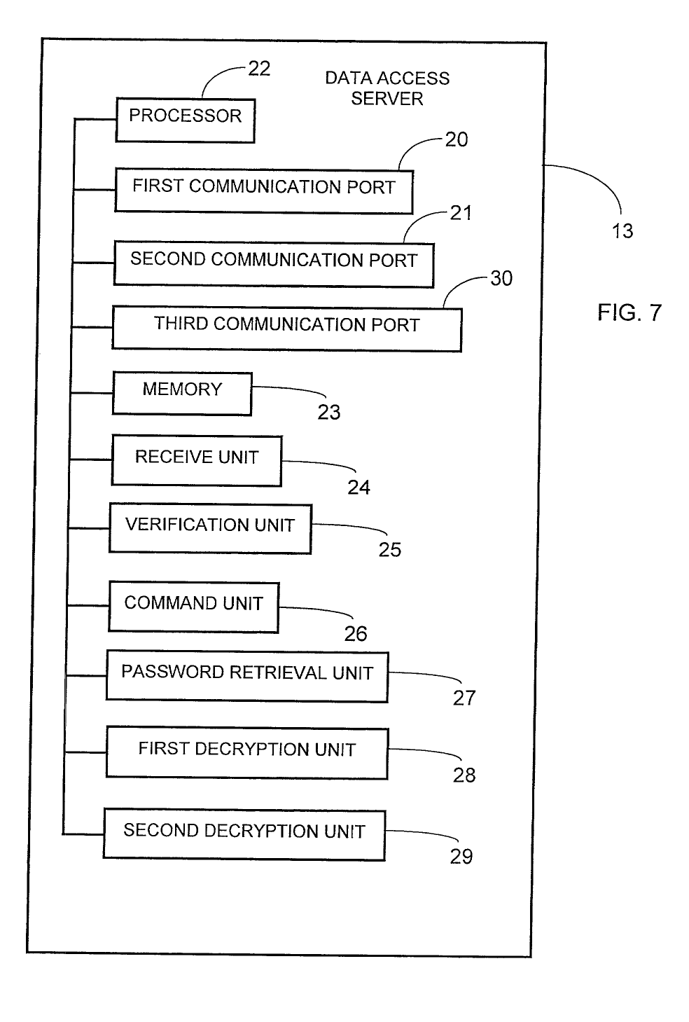

FIG. 7 is a block diagram showing functionally the data access server 13 comprising a first communication port 20 for coupling the client machine 11 thereto, a second communication port 21 for coupling the login server 14 thereto, and a processor 22 coupled to the first communication port 20 and to the second communication port 21. A memory 23 is coupled to the processor 22 for storing a user identity in respect of a registered user and a private key encrypted with a password of the user. A receive unit 24 is coupled to the processor 22 for receiving from a user a login request including an identifier of the user and supplementary data that may be used to authenticate the user. A verification unit 25 coupled to the receive unit 24 verifies that a user is registered, and a command unit 26 is coupled to the processor 22 for receiving a request by the registered user for performing a desired operation together with a session ID of the user that is allocated to the user during login and is known to the login server 14. A password retrieval unit 27 coupled to the second communication port 21 communicates the session ID of the user to the login server 14 for identification thereby and for receiving therefrom the user's password encrypted in such a manner as to enable decryption by the data access server 13. A first decryption unit 28 coupled to the password retrieval unit 27 decrypts the encrypted password so as to derive the password associated with the user during a login request, and a second decryption unit 29 decrypts the encrypted private key of the registered user having the specified unique identifier using the password. A third communication port 30 allows coupling thereto of the backup repository 15 for securing retrieval of the user's password therefrom.

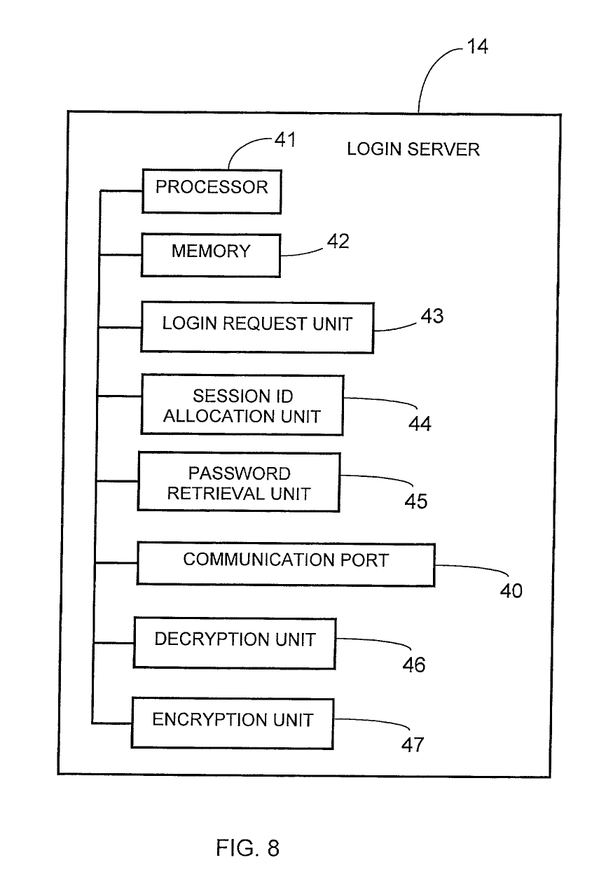

FIG. 8 is a block diagram showing functionally the login server 14 comprising a communication port 40 for coupling the data access server 13 thereto, and a processor 41 coupled to the communication port 40. A memory 42 is coupled to the processor 41 for storing a user identity in respect of a registered user and an encrypted password of the user. A login request unit 43 coupled to the processor for receives from the data access server 13 a login request including an identifier of the user. A session ID allocation unit 44 is coupled to the login request unit 43 for allocating a session ID relating to a current connection session with the data access server 13 and storing the session ID in the memory 42 in association with the user identity of the user. A password retrieval unit 45 is coupled to the communication port 40 for receiving the session ID from the data access server 13 and retrieving the encrypted password of the user. A decryption unit 46 is coupled to the password retrieval unit 45 for decrypting the encrypted password so as to derive the password associated with the user during a login request. An encryption unit 47 is coupled to the decryption unit 46 for encrypting the private key of the registered user in such a manner as to enable decryption by the data access server.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

In the method claims that follow, alphabetic characters used to designate claim steps are provided for convenience only and do not imply any particular order of performing the steps.

1. A method for performing on behalf of a registered user an operation on data stored on a publicly accessible data access server coupled to a client machine used by the registered user in such a manner as to prevent unauthorized users from using said data and without requiring decryption by the client machine, said registered user having a unique identifier known to the data access server and further having a password accessible to the data access server, said unique identifier being saved in the data access server in a user space associated with the registered user, said registered user further having a public key and a private key that is encrypted with said password to generate an encrypted private key that is stored together with the public key in said user space, the method comprising the following steps all carried out by the data access server:
(a) receiving from a user a login request including an identifier of said user and supplementary data that may be used to authenticate the user,
(b) verifying that the user is a registered user,
(c) if the user is a registered user:
i) receiving a request by the registered user for performing said operation together with a session ID of said user that is allocated to the user during login and is known to the login server,
ii) communicating the session ID of said user to the login server for identification thereby,
iii) receiving from the login server the user's password encrypted in such a manner as to enable decryption by the data access server,
iv) decrypting the encrypted password so as to derive the password associated with the user during the login request,
v) attempting to decrypt the encrypted private key of the registered user having said unique identifier using said password, and
vi) if the registered user's private key is successfully decrypted, using the registered user's private key to perform said operation on behalf of the registered user.

2. The method according claim 1, wherein the supplementary data serves as said password.

3. The method according claim 2, wherein during login the data access server further performs the following steps:
(1) encrypting the password so as to generate an encrypted password, and
(2) sending the encrypted password to a login server coupled to the data access server for storage thereby;
whereby the data access server may access the password from the login server without storing it locally.

4. The method according to claim 3, wherein in step (2) the encrypted password sent to the login server is adapted for temporary storage thereby during a current session only.

5. The method according to claim 4, further including:
vii) informing the login server upon termination of the current session so as to allow deletion of the encrypted password thereby.

6. The method according claim 1, wherein during login the data access server further performs the following steps:
(1) using the supplementary data to generate said password.

7. The method according claim 6, wherein during login the data access server further performs the following steps:
(2) encrypting the password so as to generate an encrypted password, and
(3) sending the encrypted password to a login server coupled to the data access server for storage thereby;
whereby the data access server may access the password from the login server without storing it locally.

8. The method according claim 1, wherein the password is previously known to the login server and step (c)iii) includes:
(1) sending the unique identity of the user to the login server, and
(2) receiving the password from the login server;
whereby the data access server may access the password from the login server without storing it locally.

9. The method according to claim 1, wherein in steps (c) iii) and iv) the password associated with the user is encrypted with a public key of the login server so as to enable decryption by the data access server using its public key and subsequent decryption using private key.

10. The method according to claim 2, wherein step (b) includes:
ii) generating a fingerprint of the password and comparing with a fingerprint stored in the user space associated with the registered user identified by said unique identifier.

11. A method for performing on behalf of an authorized user an operation on data stored on a publicly accessible data access server coupled to a client machine used by the registered user in such a manner as to prevent unauthorized users from using said data and without requiring decryption by the client machine, said user having a unique identifier known to the data access server and further having a password accessible to the data access server, said unique identifier being saved in the data access server in a user space associated with the registered user, said authorized user further having a public key and a private key that is encrypted with said password to generate an encrypted private key that is stored together with the public key in said user space, the method comprising the following steps all carried out by a login server coupled to the data access server:
(a) receiving from the data access server a session ID of said user associated with a current session that is allocated to the user during login and is known to the login server,
(b) using the session ID of said user to retrieve the user's password, and
(c) sending to the data access server the user's password encrypted in such a manner as to enable the data access server to:
i) decrypt the encrypted password so as to derive the password associated with the user during a login request,
ii) attempt to decrypt the encrypted private key of the registered user having said unique identifier using said password, and
iii) if the registered user's private key is successfully decrypted, using the registered user's private key to perform said operation on behalf of the registered user.

12. The method according to claim 11, further including:
(d) receiving from the data access server notification upon termination of the current session, and
(e) deleting the encrypted password.

13. The method according to claim 12, further including:
(f) automatically logging out the user after a predetermined timeout period, and
(g) deleting the encrypted password.

14. The method according to claim 11, further including during logon by the user to the data access server:
(h) receiving from the data access server an encrypted password of the registered user, and
(i) storing the encrypted password in a user space of the login server associated with the registered user for subsequent access by the data access server.

15. The method according to claim 11, wherein said password is provided during logon by the user to the data access server.

16. The method according to claim 11, further including:
viii) decrypting the user's encrypted password using the login server's private key and re-encrypting using a temporary key that is stored only in random access memory, and
ix) saving the re-encrypted password.

17. The method according to claim 16, wherein the temporary key is a symmetric key.

18. The method according to claim 16, wherein the temporary key is generated periodically.

19. A program storage device readable by machine, tangibly embodying a program of instructions executable by the machine to perform method steps for performing on behalf of a registered user an operation on data stored on a publicly accessible data access server coupled to a client machine used by the registered user in such a manner as to prevent unauthorized users from using said data and without requiring decryption by the client machine, said registered user having a unique identifier known to the data access server and further having a password accessible to the data access server, said unique identifier being saved in the data access server in a user space associated with the registered user, said registered user further having a public key and a private key that is encrypted with said password to generate an encrypted private key that is stored together with the public key in said user space, the method comprising the following steps:
(a) receiving from a user a login request including an identifier of said user and supplementary data that may used to authenticate the user,
(b) verifying that the user is a registered user,
(c) if the user is a registered user:
i) receiving a request by the registered user for performing said operation together with a session ID of said user that is allocated to the user during login and is known to the login server,
ii) communicating the session ID of said user to the login server for identification thereby,
iii) receiving from the login server the user's password encrypted in such a manner as to enable decryption by the data access server,
iv) decrypting the encrypted password so as to derive the password associated with the user during the login request,
v) attempting to decrypt the encrypted private key of the registered user having said unique identifier using said password, and
vi) if the registered user's private key is successfully decrypted, using the registered user's private key to perform said operation on behalf of the registered user.

20. A computer program product comprising a computer useable medium having computer readable program code embodied therein for performing on behalf of a registered user an operation on data stored on a publicly accessible data access server coupled to a client machine used by the registered user in such a manner as to prevent unauthorized users from using said data and without requiring decryption by the client machine, said registered user having a unique identifier known to the data access server and further having a password accessible to the data access server, said unique identifier being saved in the data access server in a user space associated with the registered user, said registered user further having a public key and a private key that is encrypted with said password to generate an encrypted private key that is stored together with the public key in said user space, the computer program product comprising:
computer readable program code for causing the computer to receive from a user a login request including an identifier of said user and supplementary data that may used to authenticate the user,
computer readable program code for causing the computer to verify that the user is a registered user,
computer readable program code responsive to the user being a registered user for causing the computer to receive a request by the registered user for performing said operation together with a session ID of said user that is allocated to the user during login and is known to the login server,
computer readable program code responsive to the user being a registered user for causing the computer to communicate the session ID of said user to the login server for identification thereby,
computer readable program code responsive to the user being a registered user for causing the computer to receive from the login server the user's password encrypted in such a manner as to enable decryption by the data access server,
computer readable program code responsive to the user being a registered user for causing the computer to decrypt the encrypted password so as to derive the password associated with the user during the login request,
computer readable program code responsive to the user being a registered user for causing the computer to attempt to decrypt the encrypted private key of the registered user having said unique identifier using said password, and
computer readable program code responsive to the user being a registered user and to the registered user's private key being successfully decrypted for causing the computer to use the registered user's private key to perform said operation on behalf of the registered user.

21. A data access server for effecting a secure transaction on behalf of a user accessing the data access server via a client machine, the data access server comprising:
a first communication port for coupling the client machine thereto,
a second communication port for coupling a login server thereto,
a processor coupled to the first communication port and to the second communication port,
a memory coupled to the processor storing a user identity in respect of a registered user and a private key encrypted with a password of said user,
a receive unit coupled to the processor for receiving from a user a login request including an identifier of said user and supplementary data that may be used to authenticate the user,
a verification unit coupled to the receive unit for verifying that a user is registered,
a command unit coupled to the processor for receiving a request by the registered user for performing a desired operation together with a session ID of said user that is allocated to the user during login and is known to the login server,
a password retrieval unit coupled to the second communication port for communicating the session ID of the user to the login server for identification thereby and for receiving from the login server the user's password encrypted in such a manner as to enable decryption by the data access server,
a first decryption unit coupled to the password retrieval unit for decrypting the encrypted password so as to derive the password associated with the user during a login request, and
a second decryption unit for decrypting the encrypted private key of the registered user having said unique identifier using said password.

22. The data access server according to claim 21, further comprising a third communication port for coupling thereto a backup repository allowing retrieval of the user's password.

23. A login server comprising:
a communication port for coupling a data access server thereto,
a processor coupled to the communication port,
a memory coupled to the processor storing a user identity in respect of a registered user and an encrypted password of said user,
a login request unit coupled to the processor for receiving from the data access server a login request including an identifier of said user,
a session ID allocation unit coupled to the login request unit for allocating a session ID relating to a current connection session with the data access server and storing the session ID in said memory in association with the user identity of said user,
a password retrieval unit coupled to the communication port for receiving the session ID from the data access server and retrieving the encrypted password of the user,
a decryption unit coupled to the password retrieval unit for decrypting the encrypted password so as to derive the password associated with the user during a login request, and
an encryption unit coupled to the decryption unit for encrypting the private key of the registered user in such a manner as to enable decryption by the data access server.
